(19) United States
(12) Patent Application Publication
(10) Pub. No.: US 2012/0131477 A1
(43) Pub. Date: May 24, 2012

(54) Social Network Device

(76) Inventor: David Victor Marsden, Berkhamsted (GB)

(21) Appl. No.: 13/301,554

(22) Filed: Nov. 21, 2011

(30) Foreign Application Priority Data
Nov. 19, 2010 (GB) 1019588.1

(51) Int. Cl. G06F 3/01; G06F 15/16

(52) U.S. Cl. 715/753

(57) ABSTRACT

The device 100 has a display 102 and a content management system 104. The device is used for showing local social networking information contained on the content management system. A user interacts with the device through an interface connected to the content management system. Information can be added to the device via an input 108.

### CROSS REFERENCE TO RELATED APPLICATIONS

This application claims the benefit of U.K. Patent Application No. GB1019588.1, filed Nov. 19, 2010.

### BACKGROUND OF THE INVENTION

The present invention relates to a device, system and method for local social networking.

Social networking focuses on building and reflecting social networks or social relations among people sharing interests and/or activities. A social network service consists of a representation of each user (often a profile), the user's social links, and a variety of additional services. These are typically individual-centred, and allow users to share ideas, activities, events, and interests within their individual networks.

Social networking websites are popular and widely used, but their use requires access to the Internet via a computer or hand-held device such as a smart phone. In addition, if the information these networks contain is stratified, it is typically according to interests and backgrounds of the user.

### BRIEF SUMMARY OF THE INVENTION

According to a first aspect of the invention, there is provided a device for social networking comprising: a display means; a content management system; and an interface means; wherein, in use, a user interacts with the interface means to cause the content management system to provide local social networking information to the display means. The fact that the device for social networking allows the user to interact directly with the information, the user does not need a computer or a smart phone.

Preferably, the local networking information is specific for a locality. Preferably, the locality is geographical.

Preferably the device for social networking further includes an input wherein, in use, the user can add personal information to the content information system. The fact that the user can add personal information means that he or she is able to access and interact with information from other uses to social network locally.

The information may be visual information, audio information, or textual information. This means that other users of the device for social networking can see what the user looks like, what their opinions might be, what kind of music they like, and what they sound like.

The information may be biometric information, and the input may be configured to recognise the user by facial recognition, voice recognition, retina scan and the like.

The information may be local social networking information. This means that the user can network socially with other users of the device for social networking.

The local social networking information may be information specific to the physical location of the device for social networking. This means that the user can network socially with information that is specific to the location of the device for social networking.

The location can be a public place. This means that the user can network socially with other uses of a museum, art gallery, shop, sports stadium, public house, restaurant, etc.

Preferably, the content management system manages a flow of data between a user and the display via the interface.

Preferably, the content management system is configured to push information to the display.

Preferably, the content management system is configured to pull information provided by the user via the interface.

Preferably, the content management system can exchange information with an email server, a web feed server, or user's social networking account.

Preferably, the interface allows a user to login, by providing a means for inputting user name and password data, or providing a means for login via a bar code, QR barcode, or an RFID device.

Preferably, the interface can interface with a number of users simultaneously.

Preferably, the interface includes a video input device which allows an image of the user to be captured.

Preferably, the interface can be used to schedule appointments.

Preferably, the interface can be used to set up discussion forums or blogs with users having similar interests.

Preferably, the display is an LED, LCD, Projection or plasma screen, a computer monitor or a television screen.

According to a second embodiment of the invention, there is provided a system for local social networking comprising two or more devices according to any preceding claim, in which the social networking information is specific for the same locality, and in which the content management system of each of the devices is connected to a locality content management system.

Preferably, the locality is geographical.

Preferably, the locality is relational.

Preferably, the locality content management system is connected to an external management system.

According to a third embodiment of the invention, there is provided a method for local social networking, the method comprising the steps of: providing a display means; providing a content management system; providing an interface means; wherein, in use, a user interacting with the interface means causes the content management system to provide local social networking information to the display means.

According to a fourth embodiment of the invention, there is provided a method for local social networking, the method comprising the steps of: providing two or more devices according to any of claims 1 to 26, in which the social networking information is specific for the same locality; connecting the content management system of each of the to a locality content management system; wherein, in use, a user interacting with the interface means causes the content management system to provide local social networking information to the display means.

According to a fifth embodiment of the invention, there is provided a computer readable product comprising code means designed for implementing the steps of the method.

According to a sixth embodiment of the invention, there is provided a computer system for local social networking system comprising means designed for implementing the steps of the method.

### DETAILED DESCRIPTION OF THE INVENTION

For a more complete explanation of the present invention and the technical advantages thereof, reference is now made to the following description and the accompanying drawing in which:

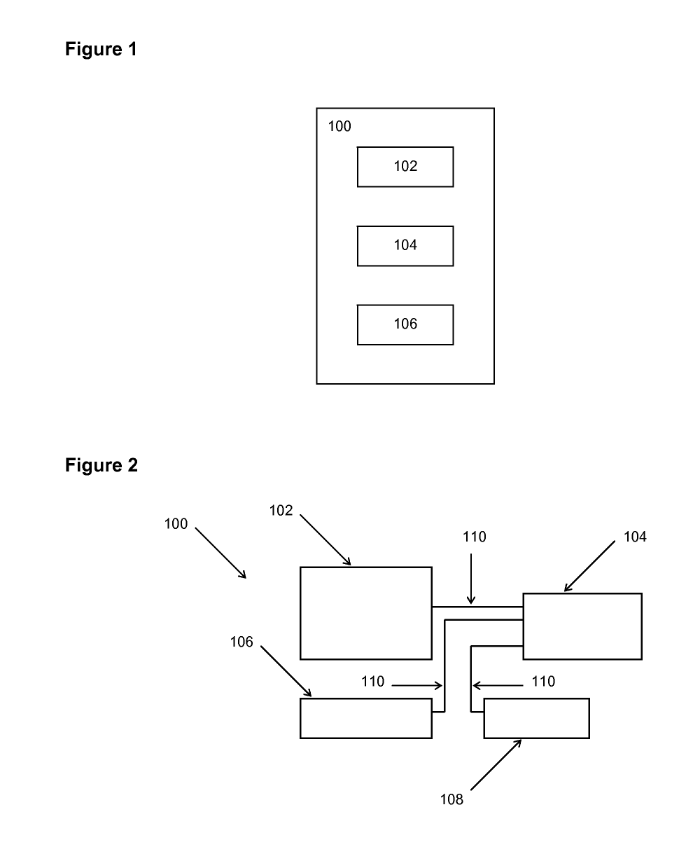

FIGS. 1 to 3 show schematics of a device for social networking of the present invention; and

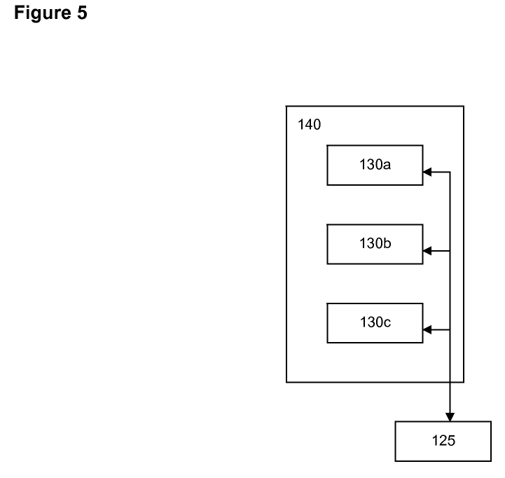

FIGS. 4 and 5 show systems for social networking of the present invention.

Embodiments of the present invention and their technical advantages may be better understood by referring to FIG. 1.

The device for social networking 100 comprises a display 102 for showing local social networking information; a content management system 104 containing local social networking information and connected to the display; and an interface 106 connected to the content management system.

Display 102 can be any kind of display suitable for showing information, such as an LED or plasma screen, a computer monitor or a television screen. The information shown on the screen is provided by content management system 104. The information displayed and its layout is context-specific to the locality of device 100. A user interacts with the information via interface 106. Interface 106 can be a keyboard, a touch screen, a position-sensing device for sensing visual gestures made with hands/arms etc, or a short-range wireless device, such as a smart phone.

In use, a user interacts with interface 106 to cause content management system 104 to select local social networking information to be shown on display 102. The fact that the device allows the user to interact directly with the information, the user does not need a computer.

Users can be either an individual or a group, and a user can remain anonymous to other users.

Interaction maybe of a kinaesthetic nature, for example the display may pulse or send unharmful current or physical sensation based information to the users e.g. active areas on screen. This means that visually impaired users can interact with the device via a form of digital brail.

Content management system 104 provides a collection of procedures used to manage information flow in the social networking environment. For example, content management system 104 manages flows of data between a user and display 102 via interface 106

Content management system 104 can comprise a processor 112 and a data store 114.

This means, for example, that content management system 104 is able to push information held in its data store to display 102, and pull information provided by the user via interface 102 for storage in the data store.

Content management system 104 manages how information is collected from a user, and how it is subsequently processed or stored. Information pulled from the user includes information specifically provided by the user, such as personal details, preferences, comments, articles, reviews and the like, and gathered information relating to the user's activities, such as frequency of visits, habits, and the like. Content management system 104 is also to generate ratings data based on comments made by other users.

Content management system 104 can exchange information from external sources, such as an email server, a web feed server (such as RSS or Atom or Twitter), a user's social networking account (e.g. a user's FaceBook Wall), and the like.

Content management system 104 can be offline or online

Interface 106 is any means that allows a user to interact with the device 100, and in particular with content management system 104. For example, the interface comprises buttons, graphics, icons and/or menus displayed on display 102 and a keypad/pointing device, a touch sensitive element, and/or a motion-sensitive element allowing a user to interact with the buttons, graphics, icons and/or menus displayed on display 102. The motion-sensitive element allows a user to interact with display 102 using gestures. It may be especially useful at times when public hygiene is important to limit epidemic spread of infectious diseases. Interface 106 provides a range of options which the user may select.

For example, a user can select a “log-in” option, which will provide a screen that allows the user to login, either by providing a means for inputting user name and password data, or by providing a means for login via a bar code, such as a QR barcode, or via an RFID device. The interface recognises the user and content management system 104 provides relevant information to the user on display 102. Content management system 104 collects log-in activity for profiling the user, assessing user loyalty, and similar.

Interface 106 can interface with a number of users simultaneously—for example, one person at device 100, and other users in its proximity and interacting via hand-held devices.

Interface 106 can include a video input device which allows an image of the user to be captured. For example, when the user selects an option to show an image from the video input device, the image data is displayed on the screen. When the user selects an option to capture the image, a count down is displayed on the screen to give time for the user to pose before the image is captured. The user than can then to save the image, delete it, share it, email it, comment on it, tag it, send it to facebook or other social networking sites.

Interface 106 can include a payment portal allowing a payment to be made by a user. For example, a user can bid for promotion on screen

Interface 106 can be used for scheduling appointments.

Interface 106 can be used to set up discussion forums or blogs with users having similar interests.

Referring now to FIG. 2, device 100 further includes an input 108 connected to content management system 104 via connection 110, which can be a wired or wireless connection (to include data networks such as 3G and 4G), or via an intranet or an Internet. Input 108 can be part of the interface, and thus includes the devices mentioned above. In addition, the information can be visual information, in which case input 108 is a camera; it may be audio information, in which case input 108 can be a microphone, or textual information. This means that other users of the device for social networking can see what the user looks like, what their opinions might be, what kind of music they like, and what they sound like.

In use, the user can add personal information to content information system 104. The fact that the user can add personal information means that he or she is able to access and interact with information from other users to social network locally.

The information can be biometric information, in which case the input is a scanner of some kind, and the input may be configured to recognise the user by facial recognition, voice recognition, retina scan and the like.

In use, the device for social networking will recognise an existing user and display social networking information specific to that user's preferences.

The information stored on content management system 104 is local social networking information. Local content supplied by a user can be inputted onto the device for social networking and displayed for a period of time on the local machine and then removed from the local machine. Where the content management system is also connected to the Internet, a user can access content via the internet. This means that the user can network socially with other users of the device for social networking.

This may be provided to the user as a pay to use service, via subscription or pay as you use, or bid for content coverage—the user may upload, send or input content to promote themselves or a group or organisation from any channels

The social networking information is restricted to a particular locality. In other words, the information is ‘local’ information rather than global. The locality can be geographical. For example the location can be an art gallery or museum. In the simplest embodiments described in the foregoing, the locality has a single device 100, and the local social networking information may be information specific to the physical location of the device for social networking. This means that the user can network socially with information that is specific to the location of the device for social networking.

The location can be a public place. This means that the user can network socially with other uses of a museum, art gallery, shop, sports stadium, public house, restaurant, etc.

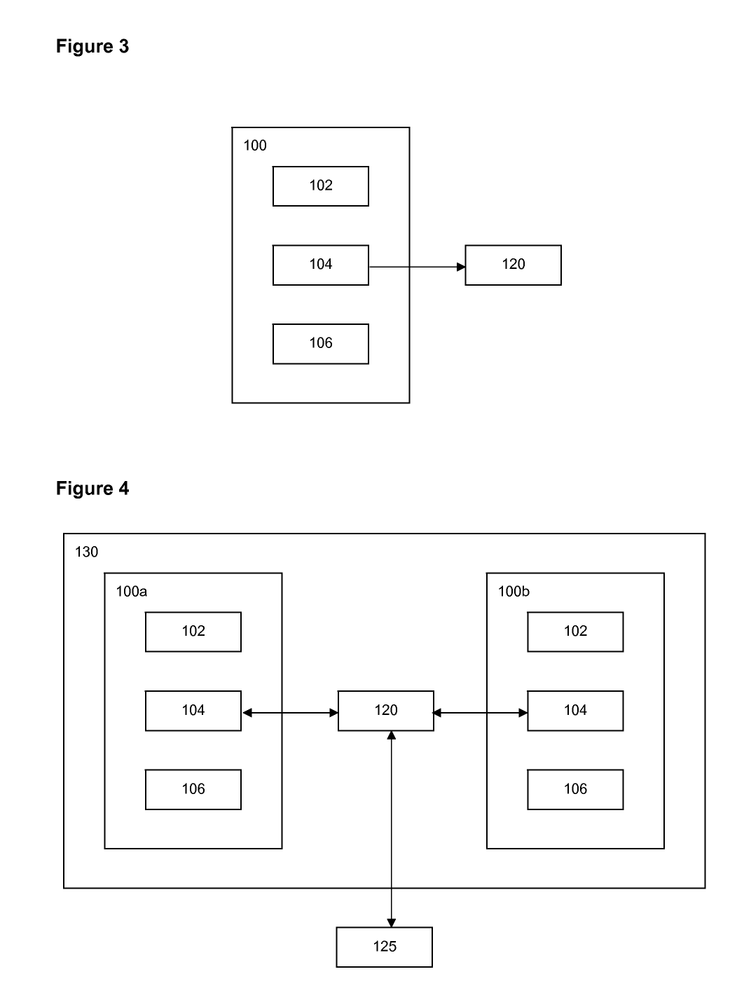

Referring now to FIG. 3, which shows a single device 100 containing social networking information specific to its physical location, content management system 104 provides information for managing device 100 to, and exchanges information with a locality management system 120. Locality content management system 120 is typically in the same physical location as device 100, and allows the management of the locality to determine what kind of information is shown on display 102. For example, when a user is not using device 100, information relating to the locality is displayed. Locality content management system 120 also determines what kinds of metrics are collected when a user logs in to the device, and also determines what user-specific information is collected when a user registers to use device 100.

The location can have one or more devices, for example in different areas of the gallery or museum. This is shown in FIG. 4, which shows a locality 130 has two devices 100a,100b each connected to locality management system 120. Here, the locality can be geographical or relational.

For example, both devices 100a,100b can be in the same geographical locality, i.e. physical location, but in different parts of it. For example, each device 100a,100b can be on different floors of the museum or gallery. Locality content management system 120 is typically in the same physical location as device 100a, 100b, and allows the management of the locality to determine what kind of information is shown on display 102. For example, when a user is not using device 100a,100b, information relating to the locality is displayed. This can be different on each device and determined, for example, according to the position of device 100a,100b in the museum or art gallery. Locality content management system 120 also determines what kinds of metrics are collected when a user logs in to the device, and also determines what user-specific information is collected when a user registers to use device 100. Locality content management system 120 can be connected to external content management system 125

Alternatively, the locality can be relational. A relational locality is one containing devices 100a,100b that serve a local networking community having a similar interest, aim, function or the like. For example, the locality can be art galleries or museums of a particular type, which will be typically geographically separated. Each gallery or museum are thus in the same relational locality, and each can have one or more devices. Another example would be a locality comprising different branches of a health club, or different branches of a department store. The local social network information will relate to users of that locality. Locality content management system 120 could be in the same physical location as device 100a, 100b, allowing local management of the locality to determine what kind of information is shown on display 102, or it could be in a different physical location, allowing head office management of the locality to determine what kind of information is shown on display 102. Locality content management system 120 can be connected to external content management system 125, which allows an external management service to control the operation of devices 100a,100b.

Referring now to FIG. 5, several localities 10a, 130b, 130c are connected to an external management service which controls the behaviour of devices over multiple localities.

Other localities may be defined in other ways that encompass a local social networking community; the key is that they are users of a device in a particular location, which can be further connected to other devices serving the community.

Social networking and sharing of information is done within the locality. For example, if the locality is a retail outlet the user could share an image while wearing a particular item of clothing to ascertain what friend might think of the outfit, or make it available to the domain to illustrate the apparel.

The locality can be any publicly accessible location such as a library, coffee shop, bar, restaurant, transport terminals, vehicles, temporary shops, live events, conferences and hospitality, hospitals, surgeries, theatres, prisons, schools, and universities.

In a context of a place of learning, the user can post information on the device, find relevant resources and control the device for tasks such as printing or sending to another playout/visual device.

The devices can be used as stand alone off-line devices, in which case some functions may not be available, or they can be used online, with a connection to the Internet.

The device can be used for providing interactive content which is either locality specific or user specific, or both. Applications running on devices 100 can change to suit the user community, and an operator, user or their audience can participate interactively to the available content, their interactions can evolve/change the available information or interface. User profiles can be created and reacted to by the audience.

The device can be arranged in any orientation which allows a user to interact via the interface. In many instances, this will be in a substantially vertical orientation, allowing the user to interact while standing; in other instances, the device will be substantially horizontal, allowing the user to interact while sitting, as for example, a table.

### Example 1

### Offline Use, Corporate Event

Business man 1 enters a profile on screen and requests to meet like-minded people within his industry. Business man 2 searches for like-minded people in a search application on screen and finds Business man 1 (based on his profile criteria) and requests a meeting at the event in 2 hours. Content management system 104 sends details to his phone and to his meeting profile section on the device for social networking

### Example 2

Customer 1 goes into a retail shop, sees device 100 and captures an image of themselves, adding details about who they are and what they like about the store. Content then appears on another display where viewer can vote for the photo and profile and opt in to following or meeting the person in the location or other chosen location.

1. A device for social networking comprising:
a display means;
a content management system; and
an interface means;
wherein, in use, a user interacts with the interface means to cause the content management system to provide local social networking information to the display means.

2. The device of claim 1, in which the local networking information is specific for a locality.

3. The device of claim 2, in which the locality is geographical and/or is a public place.

4. The device of claim 1, wherein the device further includes an input wherein, in use, the user can add personal information to the content information system.

5. The device of claim 4, wherein the information is visual information, audio information, textual information, or biometric information.

6. The device of claim 1, in which the content management system manages a flow of data between a user and the display via the interface.

7. The device of claim 1, in which the content management system is configured to push information to the display.

8. The device of claim 1, in which the content management system is configured to pull information provided by the user via the interface.

9. The device of claim 1, in which the content management system can exchange information with an email server, a web feed server, or user's social networking account.

10. The device of claim 1, in which the interface comprises any means that allows a user to interact with the device.

11. The device of claim 1, in which the interface comprises buttons, graphics, icons and/or menus displayed on the display; and a keypad/pointing device, a touch sensitive element, and/or a motion-sensitive element allowing a user to interact with the buttons, graphics, icons and/or menus displayed on the display.

12. The device of claim 1, in which the interface allows a user to login, by providing a means for inputting user name and password data, or providing a means for login via a bar code, QR barcode, or an RFID device.

13. The device of claim 1, in which the interface can interface with a number of users simultaneously.

14. The device of claim 1, in which the interface includes a video input device which allows an image of the user to be captured.

15. The device of claim 1, in which the display is an LED or plasma screen, Projection or LCD or a computer monitor or a television screen.

16. A system for local social networking comprising two or more devices for social networking, in which each device comprises:
a display means;
a content management system; and
an interface means;
wherein, in use, a user interacts with the interface means to cause the content management system to provide local social networking information to the display means; and
in which the social networking information is specific for the same locality, and in which the content management system of each of the devices is connected to a locality content management system.

17. The system of claim 16, in which the locality is geographical or relational.

18. The system of claim 17, in which the locality content management system is connected to an external management system.

19. A method for local social networking, the method comprising the steps of:
providing a display means;
providing a content management system;
providing an interface means;
wherein, in use, a user interacting with the interface means causes the content management system to provide local social networking information to the display means.

20. A computer system for a local social networking system comprising means designed for implementing the steps of the method of claim 19.
